(19) United States
(12) Patent Application Publication
(10) Pub. No.: US 2010/0011638 A1
(43) Pub. Date: Jan. 21, 2010

(54) ADVERTISEMENT BOARD

(76) Inventor: Jaegu Choi, Anyang-si (KR)

Correspondence Address: HARNESS, DICKEY & PIERCE, P.L.C., P.O. BOX 828, BLOOMFIELD HILLS, MI, 48303, US

(21) Appl. No.: 12/440,870

(22) PCT Filed: Sep. 10, 2007
(86) PCT No.: PCT/KR07/04375

§ 371 Date: Mar. 11, 2009

(30) Foreign Application Priority Data
Sep. 12, 2006 (KR) 10-2006-0088079

(51) Int. Cl. G09F 9/00; G09F 13/04; G09F 13/18

(52) U.S. Cl. 40/446; 40/546

(57) ABSTRACT

An advertisement board, which comprises one or more light emitting diodes capable of full-color display, one or more advertisement sheets, a light guide plate, and a frame, comprises: a frame which is provided with a containing portion for containing the one or more light emitting diodes, the one or more advertisement sheets, and the light guide plate, and parts of which are openable and closable in order to easily replace the one or more advertisement sheets; the one or more light emitting diodes placed at one side of the frame; the one or more advertisement sheets located on the light emitting diodes, and displaying advertisement contents by the light emitted from the light emitting diodes; the light guide plate which is located on the rear surface of the one or more advertisement sheets, diffuses the light emitted from the light emitting diodes, and sends the light to the one or more advertisement sheets to make the picture quality of the advertisement contents clearer

### TECHNICAL FIELD

This document relates to an advertisement board, and more particularly, to an advertisement board, which can increase the effect of live-action pictures unidirectionally and bidirectionally by using reflected light from a light emitting diode, reduce the volume of assistive devices since a sufficient interior space can be ensured, and enables exterior design considering aesthetic appearance.

### BACKGROUND ART

In the domestic indoor and outdoor advertising markets, there are a variety of advertising media, such as electrical signs, flex advertisements, posters, and other P.O.P advertisements.

As the importance of P.O.P ads become more apparent, image board advertising is being done as a method of showing an advertising target in an indoor space, such as the entrance, lobby, etc. of a shop, which implement advertising with picture casings, posters, or the like, by using a live-action board and an advertisement sheet.

However, in case of making an advertisement board for indoor use by using an image board, a substantial portion of the advertisement board is protruded from the wall surface to such a degree as to spoil aesthetic neighborhoods in comparison to the display area. Hence, there are limitations in designing the exterior of an advertisement board considering aethetic appearance.

Further, in case of an image board provided on an advertisement board, the effect of live-action pictures has been improved by using reflected light from a fluorescent lamp as a backlight, however, a certain interior space should be ensured in order to use the light of the fluorescent lamp, which inevitably increases the thickness and has to make assistive devices larger.

### DISCLOSURE OF INVENTION

### Technical Problem

The present invention has been made in an effort to solve the foregoing problems, and provides an advertisement board, which can increase the effect of live-action pictures unidirectionally and bidirectionally by using reflected light from a light emitting diode, reduce the volume of assistive devices since a sufficient interior space can be ensured, and enables exterior design considering aesthetic appearance.

### Technical Solution

An aspect of this document is to provide an advertisement board, which comprises one or more light emitting diodes capable of full-color display, one or more advertisement sheets, a light guide plate, and a frame, comprising: a frame which is provided with a containing portion for containing the one or more light emitting diodes, the one or more advertisement sheets, and the light guide plate, and parts of which are openable and closable in order to easily replace the one or more advertisement sheets; the one or more light emitting diodes placed at one side of the frame; the one or more advertisement sheets located on the light emitting diodes, and displaying advertisement contents by the light emitted from the light emitting diodes; the light guide plate which is located on the rear surface of the one or more advertisement sheets, diffuses the light emitted from the light emitting diodes, and sends the light to the one or more advertisement sheets to make the picture quality of the advertisement contents clearer.

In another aspect of the present invention, another one or more advertisement sheets are further placed on the rear surface of the light guide plate, a light emitting diode is further placed below the another one or more advertisement sheets, and a frame provided with a container portion for containing the another one or more advertisement sheets and the light emitting diode is further placed.

In still another aspect of the present invention, respective pattern images formed on the one or more advertisement sheets and the another one or more advertisements sheets are different from each other.

In yet another aspect of the present invention, as the one or more light emitting diodes are switched on/off, the pattern images of the one or more advertisement sheets and the another one or more advertisement sheets are respectively displayed or simultaneously displayed in multiples.

In still yet another aspect of the present invention, the one or more advertisement sheets and the another one or more advertisement sheets are made of a polycarbonate type material.

In further still yet another aspect of the present invention, one or more light emitting diodes are further placed on the entire edges of the frame.

### Advantageous Effects

According to the advertisement board of the present invention constructed as above, the following effects are obtained.

First, the contents of an advertisement desired to be displayed bidirectionally can be made to stand out respectively or simultaneously, to thus increase the effect of live-action images of the advertisement with the feeling of liveness;

Second, the volume of assistive devices can be reduced since a sufficient interior space can be ensured.

Third, the distinctivenss of the product can be improved as exterior design considering aesthetic appearance is enabled.

### BRIEF DESCRIPTION OF THE DRAWINGS

The implementation of this document will be described in detail with reference to the following drawings in which like numerals refer to like elements.

FIG. 1 is an exterior perspective view showing an advertisement board according to a first embodiment of the present invention;

FIG. 2 is a frame perspective view cut along line X˜X′ as shown in FIG. 1;

FIG. 3 is a right cross sectional view of the advertisement board cut along line X˜X′ as shown in FIG. 1;

FIGS. 4 to 6 are exterior perspective views showing a variety of live-action images of the advertisement board according to the first embodiment of the present invention;

FIG. 7 is a right cross sectional view of an advertisement board according to a second embodiment of the present invention;

FIG. 8 is a right cross sectional view of an advertisement board according to a third embodiment of the present invention;

FIG. 9 is a right cross sectional view of an advertisement board according to a fourth embodiment of the present invention;

FIG. 10 is a right cross sectional view of an advertisement board according to a fifth embodiment of the present invention; and

FIG. 11 is a right cross sectional view of an advertisement board according to a sixth embodiment of the present invention.

### BEST MODE FOR CARRYING OUT THE INVENTION

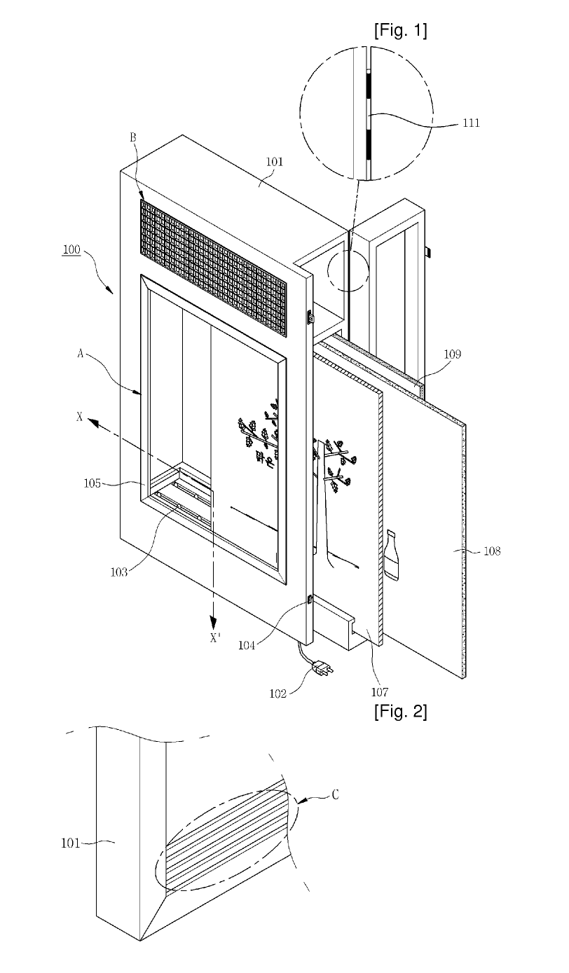

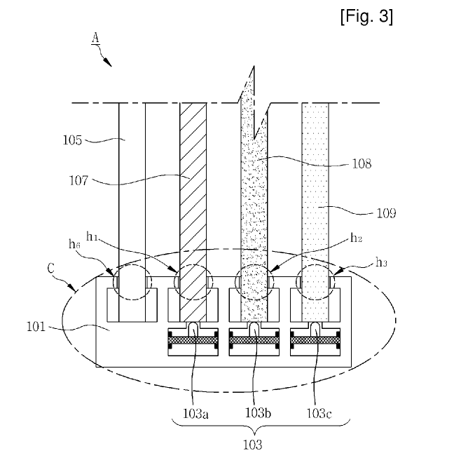

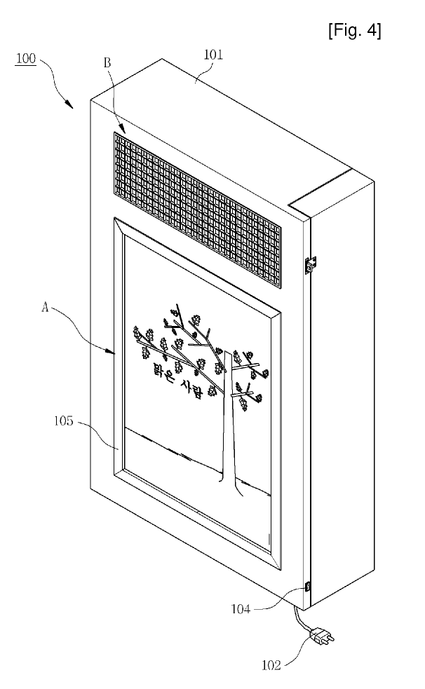

FIG. 1 is an exterior perspective view showing an advertisement board according to a first embodiment of the present invention. FIG. 2 is a frame perspective view cut along line X˜X′ as shown in FIG. 1. FIG. 3 is a right cross sectional view of the advertisement board cut along line X˜X′ as shown in FIG. 1.

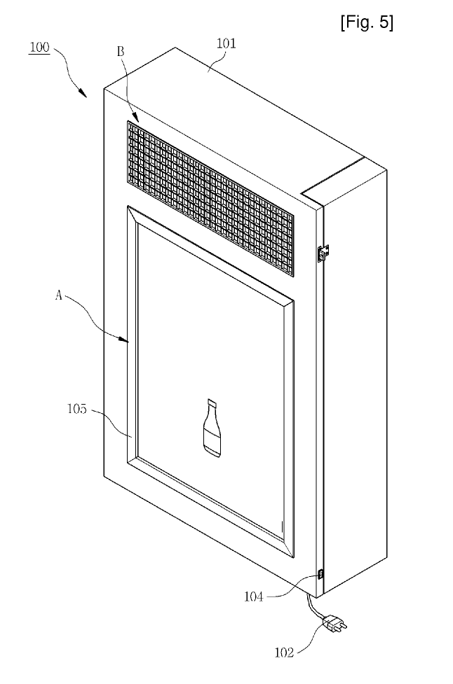

Further, FIGS. 4 to 6 are exterior perspective views showing a variety of live-action images of the advertisement board according to the first embodiment of the present invention.

Referring to FIGS. 1 to 3, the advertisement board 100 according to the first embodiment of the present invention includes a display portion A formed at one side of a frame 101 having an exterior form and a non-display portion B provided at the other side.

The display portion A is a portion for advertising a product by displaying advertisement contents to people, and the non-display portion B is a portion having a driving circuit (not shown) and a power source (not shown) that are electrically connected to the display portion A for driving the display portion A.

Here, the display portion A includes a light emitting diode 103, a first live-action board 105, one or more advertisement sheets 107 and 108, and a light guide plate 109.

At this time, the power source (not shown) is electrically connected to an external power supply 102, and is supplied with power as it is switched on and off by a switching means 104.

Moreover, the first live-action board 105, the one or more advertisement sheets 107 and 108, and the light guide plate 109 are secured through respective insertion slots h₁, h₂, and h₃ formed at a container portion C of the frame 101.

At this time, an opening and closing member (111 of FIG. 1), such as a hinge, is placed at parts of the right side of the frame 101 such that the one or more advertisement sheets 107 and 108 containing advertisement contents can be easily replaced.

Herein, as shown in FIG. 3, one or more light emitting diodes 103 are placed at lower parts of the frame 101. Such one or more light emitting diodes 103 are red (R), green (G), and blue (B) light emitting diodes, which can perform full color display of 256 gradations by a combination of colors.

The one or more advertisement sheets 107 and 108 are located above the light emitting diodes 103, and placed in order to display advertisement contents by the light emitted from the light emitting diodes 103.

At this time, as shown in FIG. 1, the one or more advertisement sheets 107 and 108, respectively, have two image patterns to be advertised to people.

However, the present invention is not limited thereto, though not shown, three or more of the one or more advertisement sheets 107 and 108 may be placed. Such one or more advertisement sheets 107 and 108 are formed in various image patterns to be advertised, thereby increasing the effect of live-action images with the feeling of liveness.

Such one or more advertisement sheets 107 and 108 are secured through the insertion slots h₁ and h₂ formed at the containing portion of the frame 101, thereby making it easy to replace the one or more advertisement sheets 107 and 108.

The light guide plate 109 is formed on the rear surface of the one or more advertisement sheets 107 and 108, diffuses the light emitted from the light emitting diodes 103, and sends the light to the one or more advertisement sheets to make the picture quality of the advertisement contents clearer.

As the light guide plate 109 is formed of a white material, which is opaque, the light emitted from the light emitting diodes 103 is not transmitted, but totally reflected and thus the light is efficiently converged, thereby making the picture quality of the advertisement contents clearer.

The first live-action board 105 is formed on the front surface of the one or more advertisement sheets 107 and 108, and displays the advertisement contents to the outside through the one or more advertisement sheets 107 and 108.

At this time, the first live-action board 105 is formed of a transparent material so as to protect the one or more advertisement sheets 107 and 108.

The transparent material of the first live-action board 105 is a polycarbonate type material, and has impact resistance, heat resistance, and cold resistance that are excellent mechanical properties.

The advertisement board 100 according to the first embodiment of the present invention can increase the effect of live-action pictures with the feeling of liveness by using a reflected light by the light emitting diodes 103 that can be switched on and off.

More specifically, when the first light emitting diodes 103a and the third light emitting diodes 103c are switched on and the second light emitting diode 103b is switched off, as shown in FIG. 4, the advertisement board 100 according to the first embodiment of the present invention displays advertisement contents desired to be expressed on the first live-action board 105.

On the other hand, when the first light emitting diode 103a is switched off and the second light emitting diode 103b and the third light emitting diode 103c are switched off, as shown in FIG. 5, another advertisement contents desired to be expressed are displayed on the first live-action board 104.

Further, when the first light emitting diode 103a, second light emitting diode 103b, and third light emitting diode 103c are all switched on, as shown in FIG. 6, all the advertisement contents desired to be expressed are displayed on the first live-action board 105.

Here, the first light emitting diode 103a, second light emitting diode 103b, and third light emitting diode 103c are electrically connected to a large-capacity capacitor (not shown) device and a switching device (not shown), and supplies the current stored in a capacitor (not shown) to the one or more light emitting diodes 103a, 103b, and 103c.

At this time, the stored current controlled by the switching device (not shown) is switched and supplied to the one or more light emitting diodes 103a, 103b, and 103c, thus enabling the effect of live-action pictures with the feeling of liveness.

Although not shown, it is also possible to represent live-action pictures with a more live feeling by applying current to the one or more light emitting diodes 103a, 103b, and 103c temporally early or late by using a current programming driving method.

As the thus-constructed advertisement board 100 according to the first embodiment of the present invention is provided with one or more advertisement sheets 107 and 108, the contents of an advertisement desired to be displayed can be made to stand out respectively or simultaneously, thereby increasing the advertising effect of the advertisement with the feeling of liveness.

Furthermore, as the size of the light emitting diodes 103 is small, a sufficient interior space can be ensured, thereby reducing the volume of assistive devices.

Moreover, the thickness of the advertisement board 100 can be narrowed, thereby enabling the exterior design of the advertisement board 100 considering aesthetic appearance.

### MODE FOR THE INVENTION

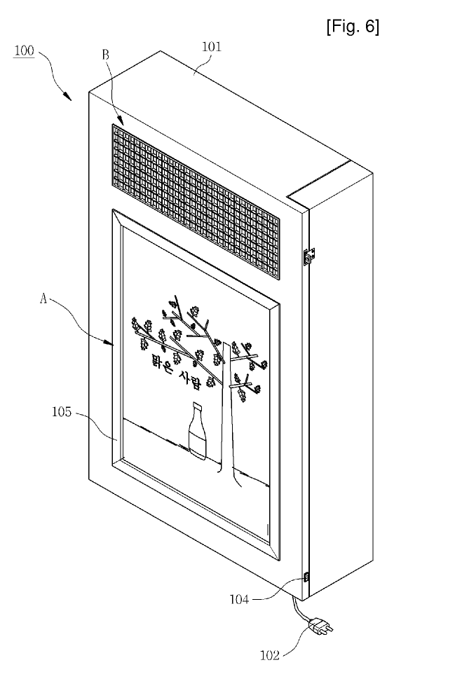

FIG. 7 is a right cross sectional view of an advertisement board according to a second embodiment of the present invention.

Referring to FIG. 7, the advertisement board according to the second embodiment of the present invention includes a display portion A formed at one side of a frame 501 having an exterior form and a non-display portion B provided at the other side in the same as in FIG. 1.

Since all of the components provided at the display portion A′ and the non-display portion (not shown) and their functions have been discussed previously, no further description is required.

The display portion A′ of the advertisement board according to the second embodiment of the present invention includes a light emitting diode 503, a first live-action board 505, one or more advertisement sheets 507 and 508, a light guide plate 509, another one or more advertisement sheets 511 and 512, and a second live-action board 513.

The first live-action board 505, the one or more advertisement sheets 507 and 508, the light guide plate 509, the another one or more advertisement sheets 511 and 512, and the second live-action board 513 are secured through respective insertion slots h₁, h₂, h₃, h_{4,} h₅, h₆, and h₇ formed at a container portion C of the frame 501.

Herein, since the functions of the frame 501, the light emitting diode 503, the first live-action board 505, the one or more advertisement sheets 507 and 508, and the light guide plate 509 have been discussed previously, no further description is required.

In the advertisement board according to the second embodiment of the present invention, another one or more advertisement sheets 511 and 512 are further formed on the rear surface of the light guide plate 509, and a second live-action board 513 is further formed on the rear surface of the another one or more advertisement sheets 511 and 512.

The another one or more advertisement sheets 511 and 512 are located above the light emitting diodes 503, and placed in order to display the contents of another advertisement bidirectionally by the light emitted from the light emitting diodes 503. At this time, the another one or more advertisement sheets 511 and 512 have a different image pattern to be advertised to people from that of the one or more advertisement sheets 507 and 508.

Likewise, the another one or more advertisement sheets 511 and 512 are secured through the insertion slots h₄ and h₅ formed at the container portion C of the frame 501. Thus, the another one or more advertisement sheets 511 and 512 can be easily replaced, thereby implementing advertising to people in various image patterns.

The light guide plate 509 is formed on the rear surface of the one or more advertisement sheets 507 and 508 and on the front surface of the another one or more advertisement sheets 511 and 512, diffuses the light emitted from the light emitting diode 503, and sends the light to the one or more advertisement sheets 507 and 508 and the another one or more advertisement sheets 511 and 5122, thereby making the picture quality of the advertisement contents clearer.

The second live-action board 513 is formed on the rear surface of the another one or more advertisement sheets 511 and 512, and displays the advertisement contents to the outside through the another one or more advertisement sheets 511 and 512. Likewise, the second live-action board 513 is formed of a transparent material so as to protect the another one or more advertisement sheets 511 and 512.

The transparent material of the second live-action board 513 is a polycarbonate type material, and has impact resistance, heat resistance, and cold resistance that are excellent mechanical properties.

As the thus-constructed advertisement board according to the second embodiment of the present invention is further provided with another one or more advertisement sheets 511 and 512, the contents of an advertisement desired to be displayed bidirectionally can be made to stand out respectively or simultaneously, thereby increasing the advertising effect of the advertisement with the feeling of liveness.

Furthermore, as the size of the light emitting diodes 503 is small, a sufficient interior space can be ensured, thereby reducing the volume of assistive devices.

Moreover, the thickness of the advertisement board 500 can be narrowed, thereby enabling the exterior design of the advertisement board 500 considering aesthetic appearance.

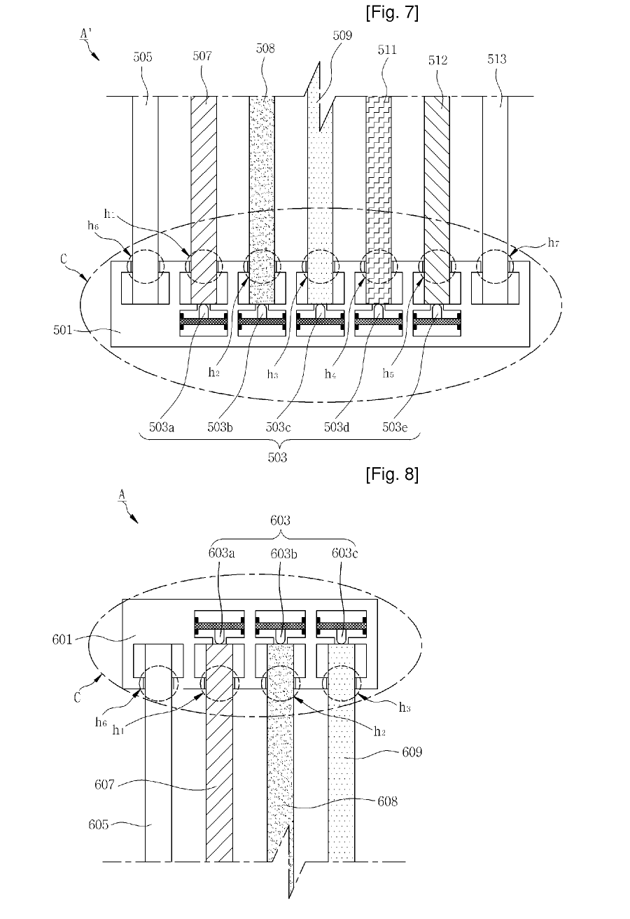

Meanwhile, one or more light emitting diodes may be placed on the uppersides or entire edges of the frame provided at the advertisement board of the present invention, so that the contents of the advertisement can be made to stand out with a more live feeling. The advertisement board according to these various embodiments of the present invention will be described with reference to FIGS. 8 to 11.

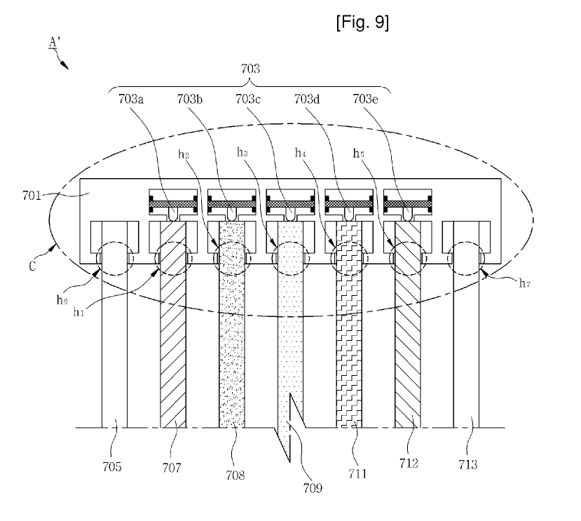

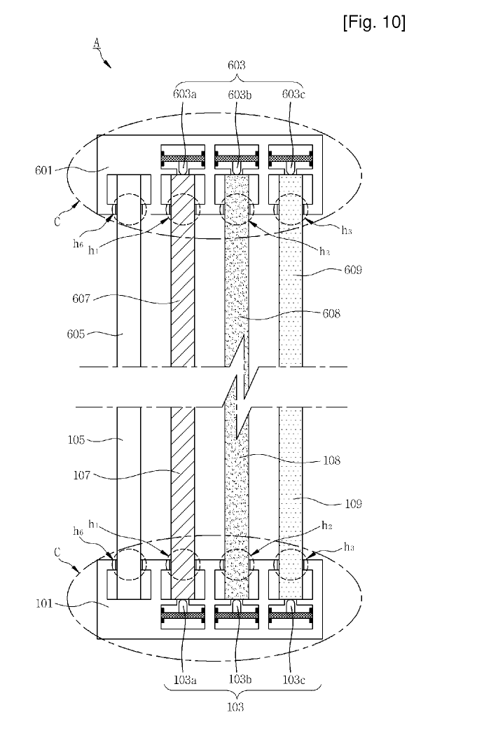

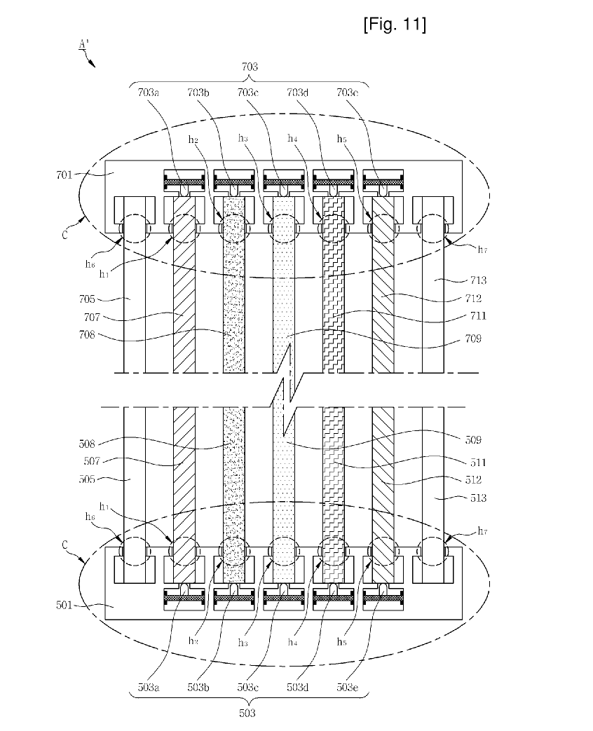

FIG. 8 is a right cross sectional view of an advertisement board according to a third embodiment of the present invention. FIG. 9 is a right cross sectional view of an advertisement board according to a fourth embodiment of the present invention. FIG. 10 is a right cross sectional view of an advertisement board according to a fifth embodiment of the present invention. FIG. 11 is a right cross sectional view of an advertisement board according to a sixth embodiment of the present invention.

Referring to FIGS. 8 and 9, a display portion A and A′ of the advertisement board according to the third and fourth embodiments of the present invention includes a light emitting diode 603 and 703, a first live-action board 605 and 705, one or more advertisement sheets 607, 608, 707, and 708, a light guide plate 609 and 709, another one or more advertisement sheets 711 and 712, and a second live-action board 713.

The first live-action board 605 and 705, the one or more advertisement sheets 607, 608, 707, and 708, the light guide plate 609 and 709, the another one or more advertisement sheets 711 and 712, and the second live-action board 713 are secured through respective insertion slots h₁, h₂, h₃, h_{4,} h₅, h₆, and h₇ formed at a container portion C located at an upper side of the frame 601 and 701.

In addition, referring to FIGS. 10 and 11, a display portion A and A′ of the advertisement board according to the fifth and sixth embodiments of the present invention includes a light emitting diode 103, 503, 603, and 703, a first live-action board 105, 505, 605, and 705, one or more advertisement sheets 107, 108, 507, 508, 607, 608, 707, and 708, a light guide plate 109, 509, 609, and 709, another one or more advertisement sheets 511, 512, 711, and 712, and a second live-action board 513 and 713.

The first live-action board 105, 505, 605, and 705, the one or more advertisement sheets 107, 108, 507, 508, 607, 608, 707, and 708, the light guide plate 109, 509, 609, and 709, the another one or more advertisement sheets 511, 512, 711, and 712, and the second live-action board 513 and 713 are secured through respective insertion slots h₁, h₂, h₃, h_{4,} , h₅, h₆, and h₇ formed at a container portion C located at an upper or lower side of the frame 101, 501, 601, and 701.

Herein, since the functions of the frame 101, 501, 601, and 701, the light emitting diode 103, 503, 603, and 703, the first live-action board 105, 505, 605, and 705, the one or more advertisement sheets 107, 108, 507, 508, 607, 608, 707, and 708, the light guide plate 109, 509, 609, and 709, the another one or more advertisement sheets 511, 512, 711, and 712, and the second live-action board 513 and 713 have been discussed previously, no further description is required.

Meanwhile, the advertisement board according to the third, fourth, fifth, and sixth embodiments of the present invention is provided with a light emitting diode 103, 503, 603, and 703 that can be switched on/off in the same way as in the advertisement board according to the second and third embodiments, and thus the effect of live-action pictures with the feeling of liveness can be further increased by using a reflected light.

Moreover, the present invention is not limited thereto, but, though not shown, one or more light emitting diodes (not shown) may be further placed on the entire edges of a frame (not shown) having an exterior form, thereby further increasing the effect of live-action pictures with the feeling of liveness by using a reflected light.

Furthermore, although not shown in the foregoing embodiments, the structure of a light guide plate (not shown) provided at the advertisement board of the present invention may be designed in such a shape as to surround one or more advertisement sheets (not shown) and another one or more advertisement sheets (not shown), thereby increasing the effect of live-action pictures with the feeling of liveness by using a reflected light.

It will be understood by those skilled in the art that the present invention can be implemented in other specific forms without changing the technical spirit or essential features of the present invention. The embodiments described above are therefore considered to be illustrative in all respects and not restrictive, the scope of the invention being indicated by the appended claims rather than by the foregoing description, and all changes and modifications which come within the meaning and range of equivalency of the claims are therefor intended to be embraced therein.

### INDUSTRIAL APPLICABILITY

The present invention can be used for a more advanced form of an advertisement board because the contents of an advertisement desired to be displayed can be made to stand out respectively or simultaneously by realizing live-action images of the advertisement with more clearness and more live feeling.

1. An advertisement board, which comprises one or more light emitting diodes capable of full-color display, one or more advertisement sheets, a light guide plate, and a frame, comprising:
a frame which is provided with a containing portion for containing the one or more light emitting diodes, the one or more advertisement sheets, and the light guide plate, and parts of which are openable and closable in order to easily replace the one or more advertisement sheets;
the one or more light emitting diodes placed at one side of the frame; the one or more advertisement sheets located on the light emitting diodes, and displaying advertisement contents by the light emitted from the light emitting diodes;
the light guide plate which is located on the rear surface of the one or more advertisement sheets, diffuses the light emitted from the light emitting diodes, and sends the light to the one or more advertisement sheets to make the picture quality of the advertisement contents clearer.

2. The advertisement board of claim 1, wherein another one or more advertisement sheets are further placed on the rear surface of the light guide plate, a light emitting diode is further placed below the another one or more advertisement sheets, and a frame provided with a container portion for containing the another one or more advertisement sheets and the light emitting diode is further placed.

3. The advertisement board of claim 2, wherein respective pattern images formed on the one or more advertisement sheets and the another one or more advertisements sheets are different from each other.

4. The advertisement board of claim 1, wherein, as the one or more light emitting diodes are switched on/off, the pattern images of the one or more advertisement sheets and the another one or more advertisement sheets are respectively displayed or simultaneously displayed in multiples.

5. The advertisement board of claim 1, wherein the one or more advertisement sheets and the another one or more advertisement sheets are made of a polycarbonate type material.

6. The advertisement board of claim 1, wherein one or more light emitting diodes are further placed on the entire edges of the frame.

7. The advertisement board of claim 3, wherein, as the one or more light emitting diodes are switched on/off, the pattern images of the one or more advertisement sheets and the another one or more advertisement sheets are respectively displayed or simultaneously displayed in multiples.

8. The advertisement board of claim 2, wherein the one or more advertisement sheets and the another one or more advertisement sheets are made of a polycarbonate type material.
